(19) United States
(12) Patent Application Publication
(10) Pub. No.: US 2023/0151887 A1
(43) Pub. Date: May 18, 2023

(54) NON-CONTACTING SEAL INCLUDING AN INTERFERENCE FIT SEAL RING

(71) Applicant: John Crane Inc., Morton Grove, IL (US)

(72) Inventors: Robert F. MCMANUS, Portsmouth, RI (US); Mark C. Savage, Cranston, RI (US)

(21) Appl. No.: 17/916,648

(22) PCT Filed: Mar. 31, 2021
(86) PCT No.: PCT/US2021/025126

§ 371 Date: Oct. 3, 2022

Related U.S. Application Data
(60) Provisional application No. 63/004,734, filed on Apr. 3, 2020.

(51) Int. Cl. F16J 15/36; F16J 15/34

(52) U.S. Cl. CPC F16J 15/36; F16J 15/3464; F16J 15/3408

(57) ABSTRACT

A seal assembly (1) for use with a rotating machine that includes a rotating shaft (2) includes a mating ring (16) having a mating ring seal face (17) and a seal ring (14) defining an interior member having an axially extending annular surface and a radially extending seal ring seal face (15). The assembly also includes a first bellows (18) that urges the seal ring toward the mating ring. At least one of the mating and seal ring seal faces includes one or more grooves (202, 206, 210) or surface features formed thereon that cause a gas to be drawn between the mating ring and the seal ring due to relative rotation between the seal ring and the mating ring and form a gas layer between the mating ring and the seal ring that urges the seal ring away from the mating ring. The assembly also includes an annular seal ring shell (22, 24, 62) that keeps the faces flat during operation.

### BACKGROUND

Exemplary embodiments pertain to the art of seals and, in particular to a non-contact seals and seal assemblies that include an interference fit seal ring.

Non-contacting seals are typically used to seal a fluid in a shafted, rotating machine. Examples of such machines include compressors, pumps, blowers and other rotating machines.

In general, non-contacting seals operate by providing a seal between two rings. The two rings can rotate relative to each other. In general, one of the rings (seal ring) is axially movable and is urged by a compression spring or a bellows into face-to-face contact with the other ring, the mating ring, which is fixed against axial movement. Depending on the configuration, one of the seal or mating rings is mated to the rotating shaft/rotor of the rotating machine and rotates with it. The rotating ring can be mated to the rotor via a shaft sleeve. For example, in some instances of a bellow seal, the seal ring rotates but in other instances the mating ring rotates.

In operation, a layer of gas is developed between the two rings that forms a seal while allowing the rings to move relative to one another without contacting each other. The gas layer is formed from process or sealing gas injected into the non-contacting seal.

### SUMMARY

Disclosed is a seal assembly for use with a rotating machine that includes a rotating shaft. The seal assembly includes a mating ring having a mating ring seal face and a seal ring defining an interior member having an axially extending annular surface and a radially extending seal ring seal face. The assembly also includes a first bellows that urges the seal ring toward the mating ring. In this embodiment, at least one of the mating and seal ring seal faces includes one or more grooves or surface features formed thereon that cause a gas to be drawn between the mating ring and the seal ring due to relative rotation between the seal ring and the mating ring and form a gas layer between the mating ring and the seal ring that urges the seal ring away from the mating ring. The assembly also includes an annular seal ring shell defining an exterior member having a foot portion defining an axially extending engagement surface, the axially extending engagement surface of the foot portion and the axially extending annular surface of the seal ring in direct interference fit along an interference diameter Ds between the axially extending engagement surface of the foot portion and the axially extending annular surface of the seal ring, the seal ring shell further including a radially extending shin portion connected to the foot portion and located radially outward of the foot portion, the foot portion at its engagement surface having an axial length greater than the axial length of the shin portion.

In any prior assembly, the grooves or surface features can draw the gas from an inner diameter of the seal ring toward an outer diameter of the seal ring. Alternatively, the grooves or surface features could draw the gas from an outer diameter of the seal ring toward an inner diameter of the seal ring. The exact direction will depend on the context in which the seal assembly is implemented and some assemblies could have 2 seals, one that draws gas in one direction and the other opposite or both in the same direction.

In any prior embodiment, the seal ring shell can further include an axially extending thigh portion connected to the shin portion and located radially outward of the shin portion, a hub extending radially outward from the connection of the shin portion with the thigh portion; and a back piece secured to the thigh portion. The first bellows can be secured to the back piece.

In any prior embodiment, the rotating machine is a pump, a compressor, a blower or a mixer.

In any prior embodiment, the engagement surface can be positioned so as to have a near-zero net moment about the center of gravity due to such engagement.

In any prior embodiment, the mating ring seal face can have a mating ring seal face width and the seal ring seal face can have a seal ring seal face width that is smaller than the a mating ring seal face width.

In any prior embodiment, the mating ring seal face width is 1.1 to 3 times larger than the seal ring seal face width.

In any prior embodiment, the assembly can include second bellows that urges the first bellows and the seal ring toward the mating ring.

Also disclosed is a dual pressurized non-contacting seal assembly for use with a rotating machine that includes a rotating shaft. The assembly includes a process side seal and an atmosphere side non-contacting seal. Either or both seals include some or all of the above combinations of elements in the prior assemblies. This assembly can further include housing surrounding the process side and atmosphere side non-contacting seals. This housing can include a gas inlet channel through which sealing gas can pass from outside the seal assembly into a region between the process side and gas atmosphere side non-contacting seals.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a cross-section of a non-contacting seal that includes an interference fit seal ring and a single bellows;

FIGS. 2a-2d show non-limiting examples of seal face surface texture patterns that can be provided on faces of the various rings in any embodiment of the seals or seal assemblies disclosed herein;

FIG. 3A is a cross-sectional view of a seal ring assembly of a non-contacting seal that includes a bellows;

FIG. 3B is a cross-sectional view of an alternative primary ring and an alternative primary ring shell embodying the features of the present invention;

FIG. 4 is an enlarged cross-sectional view of the seal ring and shell of the seal ring assembly of FIG. 3;

FIG. 5 is a cross-sectional free-body diagram of the seal ring of FIG. 4, showing forces and pressure distribution under full operating temperature and external pressure applied by process/barrier gas;

FIG. 6 is cross-sectional free-body diagram of the seal ring of FIG. 4, showing contact forces and contact pressure distribution under full operating temperature and internal pressure applied by process/barrier fluid;

FIG. 7 is a cross-section of a non-contacting seal that includes an interference fit primary ring and two bellows;

FIG. 8 is a cross-section of dual non-contacting seal assembly according to one embodiment;

FIG. 9 is a cross-section of dual non-contacting seal assembly according to one embodiment;

FIG. 10 shows gas flow paths applicable to the embodiments of FIGS. 8 and 9;

FIG. 11 is a cross sections of a non-contacting seal that includes a double bellow configuration on the process side including an interference fit and a single bellows configuration on the atmospheric side without interference fit;

FIG. 12 is a cross sections of a non-contacting seal that includes a double bellow configuration on the process side including an interference fit and a single bellows configuration on the atmospheric side with interference fit;

FIG. 13 is a cross-section of dual non-contacting seal assembly according to one embodiment;

FIG. 14 is a cross-section of an inward pumping dual non-contacting seal assembly according to one embodiment;

FIG. 15 is a cross-section of an inward pumping dual non-contacting seal assembly according to one embodiment; and

FIG. 16 is a cross-section of an inward pumping dual non-contacting seal assembly according to one embodiment.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

A detailed description of one or more embodiments of the disclosed apparatus and method are presented herein by way of exemplification and not limitation with reference to the Figures.

It has been discovered by the inventors hereof that where a non-contacting seal is operated in locations where a fluid is being sealed in a rotating machine at an elevated temperature, the sealed fluid can form a layer of deposits around the outer diameter of the seal ring. The formation of deposits in such a location can make the face of the seal ring less “flat.” This in turn can lead to high sealing gas consumption rate and, in some cases, an eventual loss of non-contacting operation due to loss of gas film thickness and stiffness. One case where such an effect can be exhibited in the case of a dual pressurized non-contacting seal that includes a process side seal and an atmosphere side seal. In particular, such effects can be seen on the process side seal.

Herein disclosed is a seal that includes a seal ring that is resistant to such loss of flatness (e.g., deformation) because it is interference fitted to an annular shell.

One of the seal rings or mating rings includes surface texture patterns so that it can draw gas between rings to cause a separation, or lift off between the rings to allow for non-contacting operation. While the specific illustrate surface texture patterns are grooves, this is not meant as limiting and any type of surface pattern could be sued so long as it supports the above described separation or lift off. As will be more fully understood based at least in part on the disclosure herein, such a seal can have hydraulically balanced seal faces with a single bellows. Further, as compared to existing technologies that used a non-interference seal ring, an expensive clean flow of fluid to the process side seal interface that was necessary to prevent or delay the formation of deposited material can be eliminated.

In some instances the seal disclosed herein can be a standalone seal. In other instances it can be used as part of a seal system such as a dual pressurized non-contacting seal that includes two seals. Regardless, the seals can be used in pumps, blowers, or other rotating machines.

Herein, the term shaft will generally be used to refer to a shaft of any rotating machine and the shaft may or may not include a sleeve thereon. In the case where a sleeve is provided, the term “shaft” shall include the combination of the shaft and the sleeve.

Aspects of the present invention are applicable in all types of seals but may be especially beneficial in seals operating in elevated temperature fluids. As an example, high temperature crude oil corrosiveness is becoming a major concern in refineries due to an increased use of sour crudes containing the above organic acids and Sulphur compounds. As such, some or all of the metallurgy of the seals may be corrosion resistant alloys such as Alloy-718 metallurgy, which is resistant to the corrosive attack even at high temperature. In addition, corrosion resistant alloys retains their inherent strength much better at high temperatures, e.g. 800° F. or higher. Such alloys, however, may have a different differential thermal expansion coefficient between an corrosion resistant shell and a commonly used seal ring material is much higher than that with low corrosion resistant alloys. Therefore, a much higher interference is required between them in order to keep the shell properly secured at elevated temperature operations.

Turning now to an overview of technologies that are more specifically relevant to aspects of the invention, a non-contacting separation seal is provided.

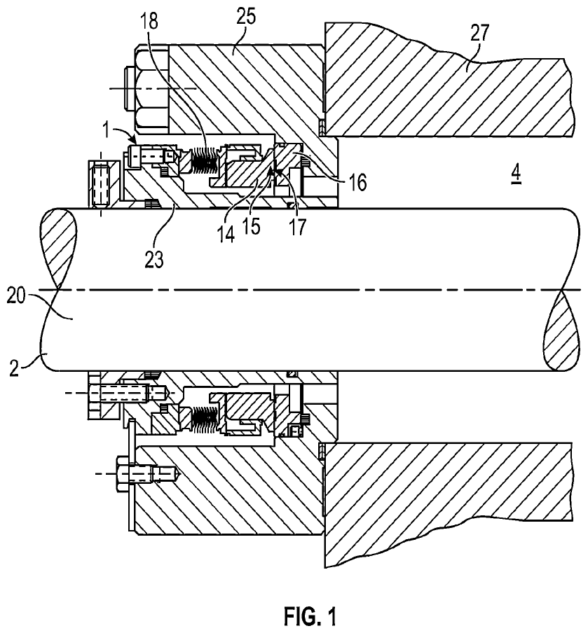

FIG. 1 shows a cross-section of a seal 1 according to one embodiment. The seal 1 is shown is a single seal configuration but it shall be understood that the seal 1 could be used in combination with another seal form a dual non-contacting seal assembly.

The seal 1 is a dry gas seal in one embodiment and, as such, operates by developing a layer of gas between a seal ring 14 and a mating ring 16 to due relative motion between the primary ring 14 and the mating ring 16. In particular, the layer of sealing gas is formed between seal faces 15, 17 of the seal and mating rings 14, 16, respectively, and keeps gas within a chamber 4 from escaping therefrom along a shaft 2. The sealing gas layer is formed from process or gas injected into the process side of the non-contacting seal and may be sourced from the chamber 4.

The seal 1 also includes a bellows 18 that urges the seal ring 14 towards the mating ring 16. One of the faces 15, 17 of the seal ring or mating ring 14, 16 can comprise a surface feature textured area, such that the rotation of the rings relative to one another causes sealing gas to be pumped between the faces 15, 17 to generate a force which opposes that applied by hydraulic forces and the bellows 18. Such sealing gas also keeps the faces 15, 17 from contacting one another.

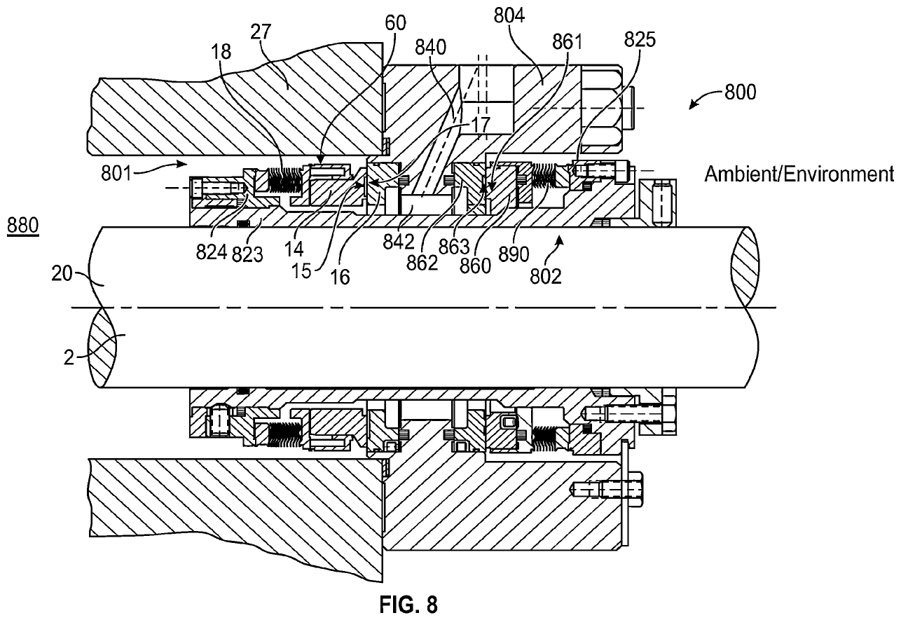

The sealing gas layer, when formed, separates the seal faces 15, 17 from each other and opposes the hydraulic forces and force from the bellows 18. Herein, at least one of the seal faces 15, 17 can include surface texture features formed therein. The surface texture features can be configured such that they draw gas in from an outer diameter of one of the faces towards it center/inner diameter. Such a configuration is applicable to situations where pressure at the outer diameter is greater than at the inner diameter. In the opposite case (e.g., where the pressure is higher at the inner diameter as shown, for example, in FIGS. 8/9), the surface texture patterns an extend outwardly from the inner diameter to the outer diameter.

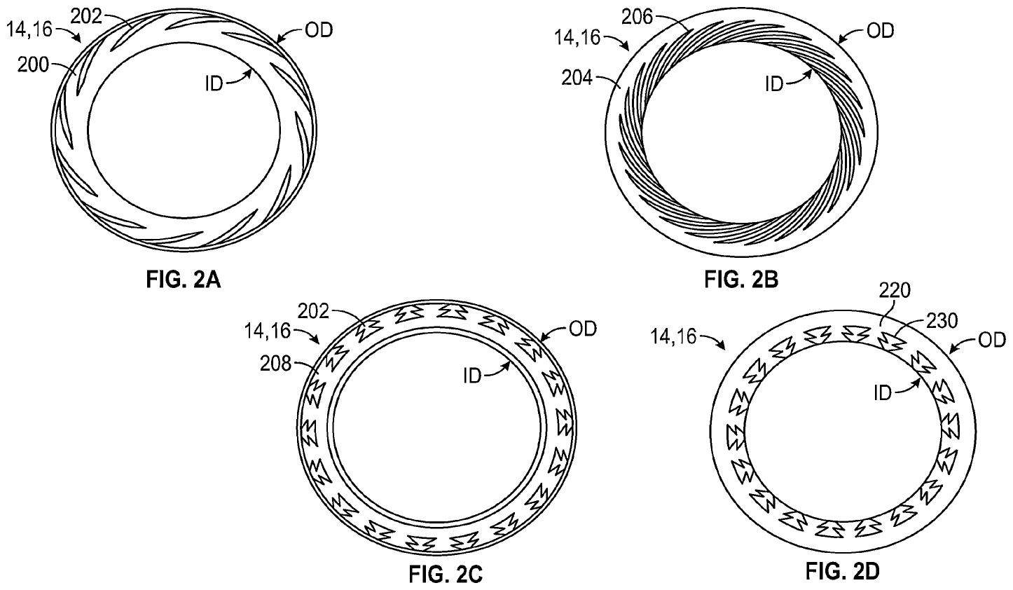

FIG. 2a shows an example of generic seal face 200 that can be a seal face of either a seal ring or a mating ring (14, 16). The surface texture patterns/grooves 202 in this face 200 are unidirectional and extend from an outer diameter OD towards an inner diameter ID.

FIG. 2b shows another example of a generic seal face 204 that can be a seal face of either a seal ring or a mating ring (14, 16). The surface texture patterns/grooves 206 in this face 204 are also unidirectional and extend from an inner diameter ID towards an outer diameter OD.

FIG. 2c shows another example of a generic seal face 208 that can be a seal face of either a seal ring or a mating ring (14, 16). The surface texture features/grooves 210 in this face 208 are bidirectional and extend from an outer diameter OD towards an inner diameter ID.

FIG. 2d shows another example of a generic seal face 220 that can be a seal face of either a seal ring or a mating ring (14, 16). The surface texture features 230 in this face 208 are bidirectional and extend from an inner diameter ID towards an outer diameter OD.

In any of these cases, as gas enters the surface texture features/grooves it is compressed as faces rotate relative one another to create the lift off force that causes the faces to separate. In any of the above examples, the surface texture patterns/grooves can have a depth from 2 to 14 microns (μm).

Referring again to FIG. 1, as shown the bellows 18 is connected to and rotates with the shaft 2. The shaft 2 is centered and rotates about a longitudinal axis 20. The seal ring 14 is connected to the bellows 18 and, as such, can move axially relative to the shaft 2 while rotating with it. The bellows 18 can be connected to the shaft 2 through a sleeve 23. The seal 1 includes a housing 25 that can be attached to a body 27 of a rotating machine. The mating ring 16 is attached to housing 25 such that they maintain a fixed relationship to one another. As will be understood, as the shaft 2 moves axially along the longitudinal axis 20 during operation, so will the bellows 18 and the seal ring 14 while the mating ring 16 remains still. The skilled artisan will realize that the compression due to the bellows 18 and the lift off due to the compressed gas can be balanced to achieve a stable distance between the faces 15, 17 during operation.

In the arrangement of FIG. 1 it is contemplated that the surface texture pattern or grooves will extend from the inner diameter towards the outer diameter of one of the faces 15, 17. Also, in the arrangement of FIG. 1, the body 27 can be part of, for example, a mixer, a fan, a turbine and the like. As shown, the seal 1 includes a single bellows 18 but as discussed below, this is not meant as limiting but may be beneficial in that in some prior systems, the seal required two bellows to hydraulically balance the seal faces to allow for reverse pressure capability. Having only a single bellows will reduce complexity.

As discussed above, in prior systems a non-contacting seal is operated in locations where a fluid is being sealed in a rotating machine at an elevated temperature, the sealed fluid can form a layer of deposits around the outer diameter of the seal ring 14. The formation of deposits in such a location can make the face of the seal ring less “flat.”

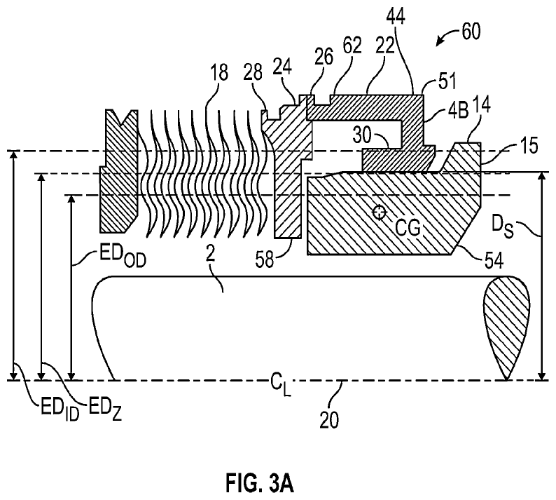

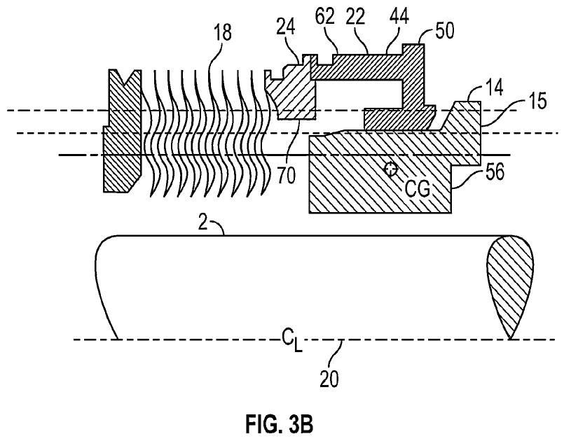

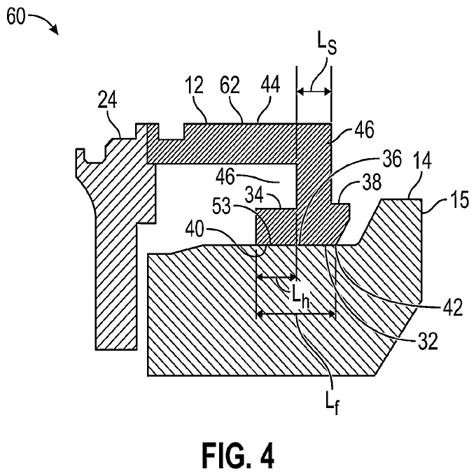

To avoid such distortion the seal ring 14 can be held by a seal ring assembly 60 embodying the present invention. With reference to FIGS. 3a, 3b, and 4, the seal ring assembly 60 includes a shell 62, the seal ring 14 and bellows 18. A rotating shaft 2, centered about a longitudinal axis 20, extends through the seal ring assembly 60. It should be noted that the term axial and axially as used in describing the embodiments mean longitudinally along the axis 20 of the shaft 2. The terms radial and radially as used in describing the embodiments mean in a plane generally perpendicular to the axis 20 of the shaft 2 toward and away from the axis.

The seal ring 14 defines an axially extending annular outer surface 53 and a radially extending seal face 15. The annular outer surface 53 is a section of the outer surface of the seal ring 14 adapted for engagement with the shell 62, to be discussed further below. It should be noted that the annular outer surface 53 is not necessarily a radially outermost surface, as evidenced by the annular surface adjacent to the seal face 15 located more radially outward. The seal face 15 of the seal ring 14 is adapted for engagement with a corresponding seal face of a mating ring. Possible materials for construction of the seal ring 14 include carbon, impregnated carbon, tungsten carbide (WC), silicon carbide (SiC), silicon/carbon graphite composite, and bronze.

The shell 62 is made up of two pieces, a front-piece 22 and a back-piece 24, which are welded together at their junction 26. Possible materials for construction of the primary ring shell pieces 22 and 24 include Alloy 718, Alloy 625, Alloy 620, Alloy 20, Alloy C-276, Alloy 42, AM 350, and stainless steel. Preferably the material for construction of primary ring shell pieces 22 and 24 is a corrosion resistant alloy. The bellows 18 is welded to the back-piece shell 24 at their junction 28. The bellows 18 can be of single or multi-ply construction. Possible materials for construction of the bellows 18 include Alloy 718, Alloy X-750, Alloy C-276, AM350, Alloy 20, and stainless steel. Preferably the material for construction of the bellows 18 is a high strength corrosion resistant alloy.

Hereinafter, such seals will be referred to as the high temperature and corrosive application seal or “HTC” seal for short.

The above described two-piece shell arrangement utilizes a geometrical shape that may be quite intricate but can be machined into the front-piece 22. Such a configuration can achieve seal face stability over the operating temperature and pressure ranges having minimum amount of face coning or distortion in either direction, which is commonly known as “OD” or “ID high.” Such enhanced face stability, in turn, results in reduced leakage and longer seal life. The enhanced, two-piece design can be used to attach a seal face to most traditional seal designs (i.e., pusher) with the similar performance benefits or other adaptive hardware.

The front-piece shell 22 is shown to have an engaging foot portion 30 into which the seal ring 14 is interference-fitted. The engaging foot portion 30 defines an axially extending engagement surface 32 for interference-fit engagement with outer surface 53 of the seal ring 14. The foot portion 30 has an inner foot portion 34, a middle foot portion 36, and an outer foot portion 38. The contact region of the engagement surface 32 at the back of the engaging foot portion is the heel 40 and its front part is the toe 42. Between the inner foot portion 34 and an upper shell region or thigh portion 44, there is a recess 46, whereas the annular region joining the thigh portion 44 and the foot portion 30 is the shin portion 48. The shin portion 48 extends radially from the foot portion 30. A front shell piece 22 with the hub portion 50 can be included as shown in FIG. 3b but is omitted is shown by line 51. in FIG. 3. The shin portion 48 has an axial length Ls that allows the shin portion to flex upon the seal ring 14 interference-fitted into the front piece shell 22. The inner foot portion 34 at its engagement surface, near the heal 40, has an axial length Lh. The foot portion 30 at its engagement surface 32 has an axial length Lf. The axial length Lf of tie foot portion 30 at its engagement surface is preferably greater than the axial length Ls of the shin portion. This increased contact region between the foot portion 30 and the seal ring 14, as compared to prior art seal designs, allows the pressure at the interface to be less concentrated at one particular point.

Furthermore, two possible primary ring nose configurations are shown in FIGS. 3a and 3b, one having a blunt nose 54 as shown in FIG. 3a and the other having a step nose 56 as shown in FIG. 3b. The blunt-nose 54 configuration is typically used with the hard seal ring materials e.g. silicon and tungsten carbides, whereas the step-nose 56 configuration is typically used with the softer materials like carbon. Also, FIGS. 3a and 3b show two possible configurations of the back-piece shell 24. In the conventional configuration as shown in FIG. 3a, this back-piece shell 24 inside diameter (ID) is extended low at 58 towards the inside diameter of seal ring 14. In the second configuration as shown in FIG. 3b, the back-piece shell 24 is truncated at 60 to have a higher ID.

To control the contract pressure distribution caused by the interference fit between the foot portion and the seal ring mating surface, preferably, the ratio (Lh/Lf) of inner foot portion length Lh at its engagement surface to foot portion length Lf at its engagement surface is greater than 0.5. More preferably, the ratio (Lh/Lf) of inner foot portion length Lh at its engagement surface to foot portion length Lf at its engagement surface is between 0.500 and 1.000. It is important to distribute this contact pressure about the body center of rotation to achieve a near zero net moment on the seal ring. This is necessary to maintain face flatness as the application pressure and temperature change. Traditional shell designs, having an inner foot portion length to foot portion length at their engagement surfaces ratio closer to zero (0), do not have an evenly distributed contact pressure and exhibit difficulty controlling face flatness.

The dimensions (e.g. lengths and thicknesses) of all these aforesaid regions described in the previous paragraphs, including the seal ring dimensions, are treated as parameters for the optimization process and are iteratively designed to get optimal performance characteristics. These control parameters allow for precise adjustment to control the interference contact pressure, the contact stress, and face stability for a variety of primary ring geometries and materials over a wide range of operating temperatures and pressures or a specific set of temperatures and pressures. The optimized design is thermally insensitive and has an axially constant contact stress distribution in the interference-fit region. The control parameters: inner foot portion 34, outer foot portion 38, shin portion 48, hub portion 50 and thigh portion 44, can be adjusted in thickness and length to accommodate varying seal ring geometries and materials. Seal geometries that tend to be more asymmetrical about the cross-sectional center of gravity/rotation, would require more asymmetry in the lengths and thicknesses of these control parameters. The relative location of the front-piece shell with respect to the seal ring is also a design control parameter to further manage face coning or distortion due to relaxation of the interference-fit caused by changes in temperature.

In one embodiment, the front-piece shell 22 is joined to the back-piece shell 24 after the initial interference-fitting of the front piece shell 22 with the seal ring 14. This process eliminates bending stresses and moments in the area of the hinge that are present in the traditional one-piece arrangements.

In the embodiment of FIGS. 3 and 4 (as well as others that include a seal ring assembly 60), the nominal interference diameter DS, which is also called the sealing diameter, is designed to be very close to the Mean Effective Diameter EDZ of the bellows as shown in FIG. 3. The Effective Diameter or “ED” of a bellows is a fictitious diameter up to which the applied pressure effectively penetrates to exert a closing force on the seal. This is akin to the “balance diameter” of a pusher-type seal. The Mean Effective Diameter is a theoretical effective diameter at zero differential pressure applied on the primary ring 14, which is taken to be the arithmetic mean of the bellows core outside and inside diameters. The seal face 15 of the seal ring 14 is designed so that the Mean Effective Diameter position gives rise to an initial balance at zero differential pressure in which the Mean Effective Diameter EDZ passes through the seal face 15 as shown in FIG. 3.

The seal ring 14 can be asymmetrical and balanced. The illustrated seal ring 14 is considered asymmetrical because the two sides of the seal ring 14 located axially from its center of gravity CG are not symmetrical. The illustrated seal ring 14 is considered balanced because the Mean Effective Diameter EDZ of the bellows 18 passes through the seal face 15 at zero differential pressure.

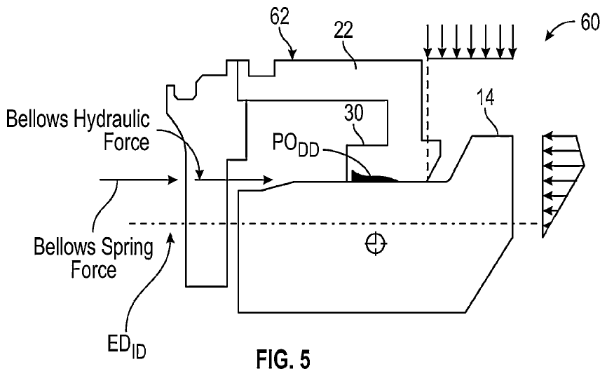

When external pressure differential is applied, the bellows effective diameter shifts downward to a lower value EDOD, as shown in FIGS. 3 and 5. Again, the seal face has been so designed that the above ED shift increases the balance ratio to an adequate level, which is based on the prior experience with conventional non-contacting seals, so that leakage is minimized

In more detail, FIG. 5 shows the external pressure acting on the seal ring 14. As seen, while the full external pressure acts on the overhung portion of the seal ring 14 outside the engaging foot portion 30 of the shell 62, on the face 15, however, the pressure decreases to a zero differential level at the ID. Although the face pressure profile is shown to be linear, in actuality, it could be curved inward or outward, depending on the effects of the seal face surface texturing features (or grooves).

The net axial force (including force from lift off created by the surface texture features acting on the seal ring 14 tends to cause axial slippage compress the bellows. between the seal ring 14 and the shell 62 at the contact region and push the seal ring 14 towards the back-piece shell 24.

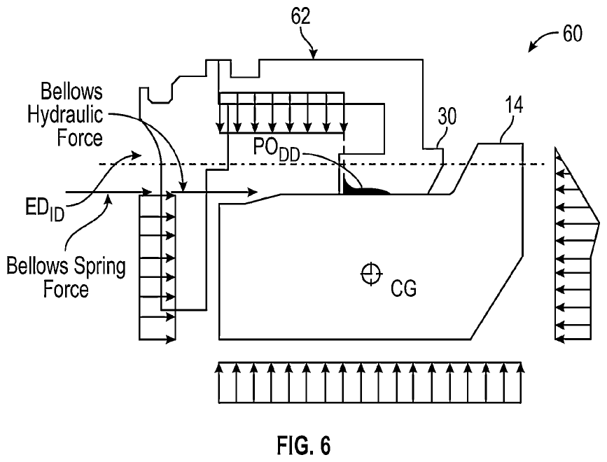

Similarly, when the internal differential pressure is applied, the bellows effective diameter shift upward from EDZ to EDID, as shown in FIGS. 3 and 6. Similar to the external pressure situation, the seal face design ensures that the new balance ratio at the internal pressure meets the design requirement.

By locating the inference diameter DS very close to the effective diameter EDZ of the bellows at zero differential pressure, the net axial force in the axial direction is minimized under internal pressure and external pressure as provided above. Preferably, the interference diameter DS is within plus and minus 10% (+10% and −10%) of the effective diameter EDZ of the bellows at zero differential pressure. More preferably, the interference diameter DS is within +6% and −6% of the effective diameter EDZ of the bellows at zero pressure. It is important to minimize the hydraulic forces acting in an axial direction to move the seal ring relative to the shell. As these forces increase, the amount of contact force provided by the interference fit must be increased to prevent movement.

As discussed above, while the interference fit diameter does not change, the effective diameter does vary with system pressure. Depending on the application, it may be desirable to bias the interference diameter toward either extreme of the effective diameter shift range.

To assemble the seal ring assembly 60 as shown in FIG. 3, the seal ring 14 is first interference-fitted into the front-piece shell 22 that is then welded to the back-piece shell 24 and the bellows 18. The shape of the front-piece shell 22 has been optimized in such a way that the extent of the contact region between its engaging foot portion 30 and the seal ring 14 is almost 100%, extending from its heel 40 to the toe 42. In contrast, a conventionally interference-fitted primary-ring assembly will have a relatively concentrated contact near the heel 40, extending over about 20% of the corresponding foot portion length.

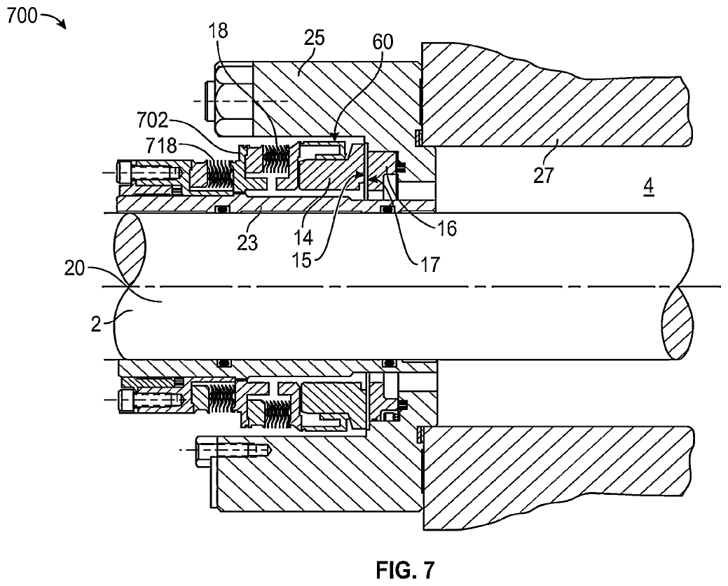

In the above discussion, a single bellows 18 has been utilized. In one embodiment, multiple bellows may be utilized. For example, with reference to FIG. 7, in an alternative embodiment, a seal 700 is provided that includes generally the same elements as the seal 1 of FIG. 1 but has a second bellows 718. The second bellows 718, as shown, is connected between the sleeve 23 and the first bellows 18. In particular, a ring 702 or other carrier can be provided between the first and second bellows 18, 718. The ring 702 is moveable relative to the shaft 2 in one embodiment.

The above described embodiments have been illustrated as being related to a single seal system. In such systems, the sealed gas typically serves as gas that is being drawn between the rings. In other embodiments, a seal system having two or more seals is provided. One or more of the seals are HTC seals as disclosed herein and shown, for example, in FIGS. 1 and 7.

In one embodiment there is provided a dual, non-contacting seal system/assembly for a rotating machine configured to inhibit the emission of process fluid between a housing and a rotating shaft. The seal system can include a process side non-contacting seal, an atmosphere side non-contacting seal and a separation gas supply subsystem that provides a separation gas to an area between the seals. The process side seal can be an HTC seal and the atmosphere side seal can be any type of non-contacting seal including an HTC seal. In such a system, the process side non-contacting seal can include a mating ring having a process side mating ring seal face and a seal ring defining an interior member having an axially extending annular surface and a radially extending process side seal ring face. One or more bellows are provided that urge the first seal ring toward a mating ring. One or both of the seal rings and mating rings can include surface texture features that cause lift-off between the faces of the rings due to relative rotation between them. The process side seal ring is interference fit to an annular seal ring shell as described above. The seal assembly includes a housing surrounding the process side and atmosphere side non-contacting seals and including a gas inlet channel through which gas can pass from outside the seal assembly into a region between the process side and atmosphere side non-contacting seals. This gas is drawn, in normal operation as more fully described below, outwardly from the shaft through the process side and atmosphere side non-contacting seals and directed in to a process chamber and to atmosphere, respectively.

With reference now to FIGS. 8-10, an assembly 800 including a process side non-contacting seal 801 and an atmosphere side non-contacting seal 802 is illustrated. It shall be understood that the exact configuration shown is not required and for generality the terms first and second seals can replace process and atmosphere herein in any configuration. The assembly include a housing 804 that surrounds portions of the first and second dry gas seals 801, 802. The housing 804 can be attached to a body 27 of any type or rotating machine that includes as rotating shaft 2 having a shaft axis 20. For example, the body 27 can be a pump body. The housing 804 surrounds portions of the first and second dry gas process and atmosphere side non-contacting seals 801, 802 and defines a gas inlet channel 840 through which gas can pass from outside the seal assembly into a region 842 (gas chamber) between the second seals 801, 802. The manner in which the gas travels from the inlet channel 840, into the gas chamber 842 and though the first and second seals 801, 802 is discussed in more detail below.

In the illustrated embodiment, the first and second seals are process and atmospheric sided seals. Thus, as shown, both the process side and atmosphere side seals have two rings, one of which rotates with the shaft 2. To that end, a sleeve 823 is provided that is configured and arranged so that it carries or otherwise supports a rotating ring for each seal. The sleeve 823 is connected to and rotates with the shaft 2 It shall be understood that while the sleeve is shown as a single piece that couples rotating rings of the process side and atmosphere side non-contacting seals 801, 802 to the shaft 2, the sleeve 823 could be formed of multiple pieces.

The process side non-contacting seal 801 can be a seal as shown in either FIG. 1 or FIG. 7 or variations thereof. In more detail, the process side non-contacting seal 801 includes a seal ring 14 and a mating ring 16 configured as above. Due to relative motion between the seal ring 14 and the mating ring 16 a layer of gas is developed between them. In particular, the layer of gas is formed between seal faces 15, 17 of the seal and mating rings 14, 16, respectively, and keeps gas within a chamber 4 from escaping therefrom along a shaft 2. The gas layer is formed from process or sealing gas injected into the non-contacting seal and may be sourced from the chamber 4.

The process side seal 801 can include one or more bellows. As shown, the seal 801 includes bellows 18 that urges the seal ring 14 towards the mating ring 16. Of course, additional bellows could be used to urge the rings together. For example, the process side seal 801 can include a second bellows 718 arranged relative to the first bellows 18 in a manner that is the same or similar to that shown in FIG. 7.

One of the faces 15, 17 of the seal ring or mating ring 14, 16 can comprise a grooved or textures area, such that the rotation of the rings relative to one another causes seal gas to be pumped between the faces 15, 17 to generate a force which opposes that applied by the bellows 18. Such gas also keeps the faces 15, 17 from contacting one another.

The gas layer, when formed, separates the seals faces 15, 17 from each other and opposes the bellows 18. Herein, at least one of the seal faces 15, 17 can include grooves or other surface features formed therein. The grooves can be configured such that they draw gas in from an inner diameter of one of the face towards it outer diameter. Such a configuration is applicable to situations where pressure at the inner diameter is greater than at the outer diameter. Examples of such grooves are shown in FIGS. 2b/2d. As discussed above, In any of these cases, as gas enters the grooves is compressed as one face rotates to create the lift off force that causes the faces to separate.

Referring again to FIG. 8, as shown the bellows 18 is connected to and rotates with the shaft 2. The shaft 2 is centered and rotates about a longitudinal axis 20. The seal ring 14 is connected to the bellows 18 and, as such, can rotate with and move axially relative to the shaft 2. The bellows 18 can be connected to the shaft 2 through a sleeve 823. As shown, an optional attachment element 824 connects the bellows 18 to the sleeve 823 but this could be omitted and the bellows 18 could be connected directly to the sleeve 823.

The assembly includes a housing 804 that can be attached to a body 27 of a rotating machine. The mating ring 16 is attached to housing 804 such that they maintain a fixed relationship to one another. As will be understood, as the shaft 2 moves axially along the longitudinal axis 20 during operation, so will the bellows 18 while the mating ring 16 remains still. The skilled artisan will realize that the compression due to the bellows 18 and the lift off due to the compressed gas can be balanced to achieve a stable distance between the faces 15, 17 during operation.

As discussed above, in prior systems a non-contacting seal is operated in locations where a fluid is being sealed in a rotating machine at an elevated temperature, the sealed fluid can form a layer deposits around the outer diameter of the seal ring. The formation of deposits in such a location can make the face of the seal ring less “flat.”

To avoid such distortion the seal ring 14 can be held by a seal ring assembly 60 embodying the present invention and that was discussed above with respect to FIGS. 3-6 above. All of the disclosure in the above is, thus, applicable to the seal ring assembly 60 shown in FIG. 8.

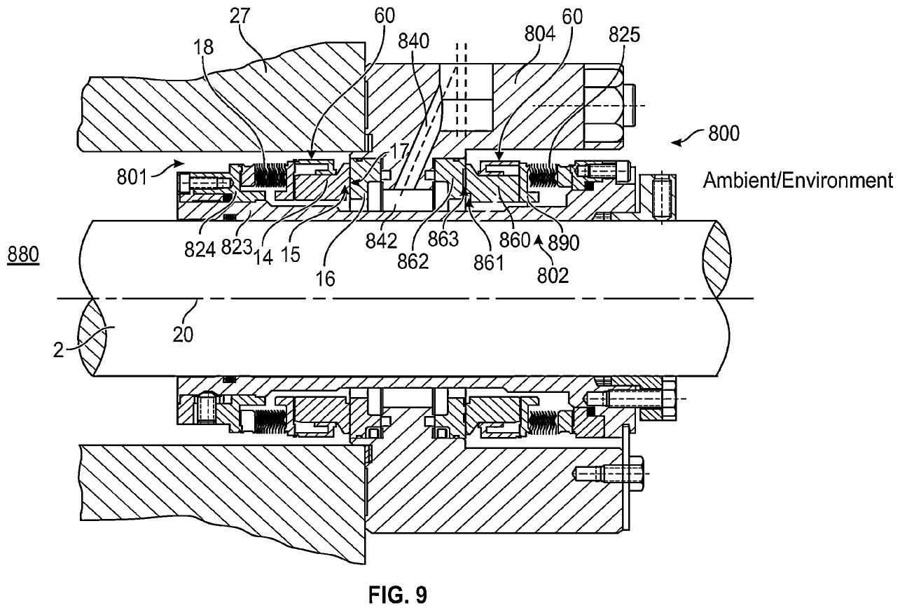

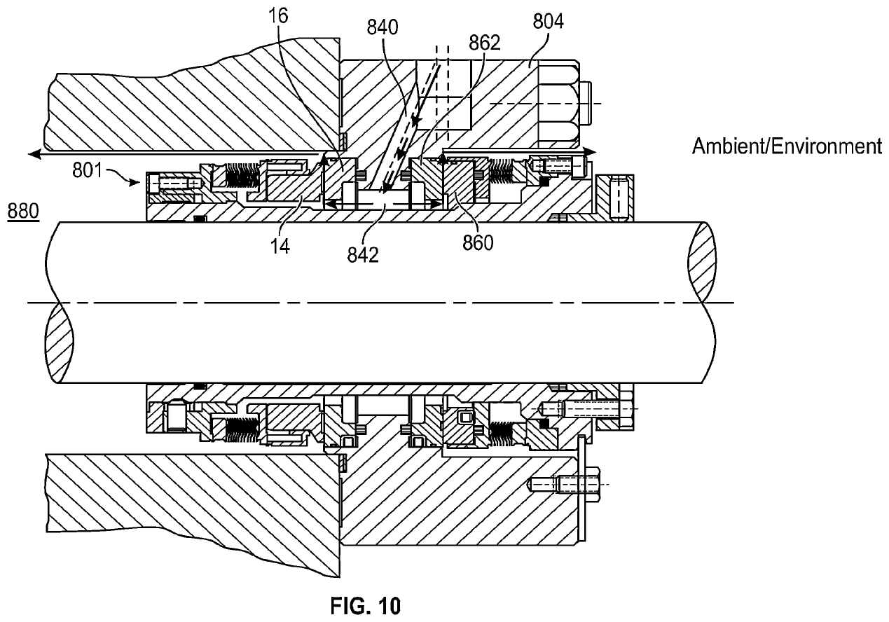

Similar to the process side seal 801, the atmosphere side seal 802 includes an atmosphere side seal ring 860 and an atmosphere side mating ring 862. The atmosphere side seal ring 860 is coupled to the shaft 2 and rotates with it. As shown, the atmosphere side seal ring 860 is connected in a conventional manner that does not include the particular seal ring assembly 60 of the process side seal 802. The skilled artisan will realize that the atmosphere side seal 802 could be so configured. Such a configuration is shown in FIG. 8. The assemblies in FIGS. 8 and 9 work in a similar manner and both have the sealing gas flow paths described in relation to FIG. 10 below.

Similar to the process side seal one of the faces 861, 863 of the seal ring or mating rings 860, 862 of the atmosphere side seal 802 can comprise a grooved or textured area, such that the rotation of the rings relative to one another causes seal gas to be pumped between the faces thereof to generate a force which opposes that applied to the seal ring 860 by a biasing device. Such gas also keeps the faces of the atmosphere side seal from contacting one another. As shown in FIG. 9, the biasing device is a bellows 890. In alternative embodiments, the biasing device can be a spring or an equivalent thereof. The seal ring assembly 860 is connected to and biased by biasing member 890 which is coupled to the sleeve 823.

In operation, the rotating shaft 2 can be operably coupled to a pump impeller or other device (not shown) disposed in a process cavity 880 of a rotating machine. Process fluid present in the process cavity 880 can be sealed from the environment by a seal assembly 800. While seal assembly 800 is depicted and described with two seals 801, 802, a greater or fewer number of seals are contemplated. Additionally, in some embodiments, a shroud, bushing, labyrinth, or clearance seal can extend over a radial opening formed between the rotating shaft 2 and the housing 804, thereby further inhibiting the free flow of process fluid from the process cavity 880 to the environment.

As shown the process side bellows 18 and the biasing member 890 are both connected to and rotate with the shaft 2. The shaft 2 is centered and rotates about a longitudinal axis 20. The seal ring 14 is connected to the bellows 18 and, as such, can rotate with and move axially relative to the shaft 2. The bellows 18 can be connected to the shaft 2 through the sleeve 823. As shown, an optional attachment element 824 connects the bellows 18 to the sleeve 823 but this could be omitted and the bellows 18 could be connected directly to the sleeve 823.

Similarly, seal ring assembly 860 is connected to the biasing member 890 and, as such, can rotate with and move axially relative to the shaft 2. The biasing member 890 can be connected to the shaft 2 through the sleeve 823. As shown, an optional attachment element 825 connects the bellows 18 to the sleeve 823 but this could be omitted and the bellows 18 could be connected directly to the sleeve 823.

A fluidic path can be defined between the rotating rings (e.g., seal rings 14, 860) and the stationary rings (e.g., mating rings 16, 862) through which a sealing gas can flow (as depicted in FIG. 10 by a series of arrows). The sealing gas can be any appropriately dense gas, such as carbon dioxide (CO2), nitrogen (N2), air, steam, or other gases. The sealing gas can be introduced into the fluidic path via a sealing gas inlet 840. Thereafter, the sealing gas can flow through a conduit into the gas chamber 842, where it can be divided into a process side seal gas flow and an atmosphere side seal gas flow. The process side seal gas flow can flow between the seal ring and mating ring 14, 16 of the first seal 801 and into the process chamber 880. The atmosphere side seal gas flow can flow between the seal ring and mating ring 860, 862 of the atmosphere side seal 802 and be released to the environment. In both the process side and atmosphere side gas flows the gas flows radially outward from the shaft 2 between the seal faces.

FIG. 9 shows another embodiment that is similar to that shown in FIG. 8. In this embodiment, the process side seal 801 includes two bellows, 18 and 718 The configuration of these two bellows is the same or similar to that shown in FIG. 7 above. In this embodiment, the assembly include a housing 804 that surrounds portions of the first and second dry gas seals 801, 802. The housing 804 can be attached to a body 27 of any type or rotating machine that includes as rotating shaft 2 having a shaft axis 20. For example, the body 27 can be a pump body. The housing 804 surrounds portions of the first and second (process and atmosphere side) non-contacting seals 801, 802 and defines a gas inlet channel 840 through which gas can pass from outside the seal assembly into a region 842 (gas chamber) between the second seals 801, 802. The manner in which the gas travels from the inlet channel 840, into the gas chamber 842 and though the first and second seals 801, 802 is discussed in more detail below.

In the illustrated embodiment, the first and second seals are process and atmospheric sided seals. Thus, as shown, both the process side and atmosphere side seals have two rings, one of which rotates with the shaft 2. To that end, a sleeve 823 is provided that is configured and arranged so that it carries or otherwise supports a rotating ring for each seal. The sleeve 823 is connected to and rotates with the shaft 2 It shall be understood that while the sleeve is shown as a single piece that couples rotating rings of the process side and atmosphere side non-contacting seals 801, 802 to the shaft 2, the sleeve 823 could be formed of multiple pieces.

The seal ring 14 can be held by a seal ring assembly 60 embodying the present invention and that was discussed above with respect to FIGS. 3-6 above. All of the disclosure in the above is, thus, applicable to the seal ring assembly 60 shown in FIG. 8

In more detail, the process side non-contacting seal 801 includes a seal ring 14 and a mating ring 16 configured as above. The seal ring 14 can be held by a seal ring assembly 60 embodying the present invention and that was discussed above with respect to FIGS. 3-6 above. All of the disclosure in the above is, thus, applicable to the seal ring assembly 60 shown in FIG. 8

Due to relative motion between the seal ring 14 and the mating ring 16 a layer of gas is developed between them. In particular, the layer of gas is formed between seal faces 15, 17 of the seal and mating rings 14, 16, respectively, and keeps gas within a chamber 4 from escaping therefrom along a shaft 2. The gas layer is formed from process or sealing gas injected into the non-contacting seal and may be sourced from the chamber 4.

The process side seal 801 show includes two bellows 18, 718 that urge the seal ring 14 towards the mating ring 16. One of the faces 15, 17 of the seal ring or mating ring 14, 16 can comprise a grooved or textured area, such that the rotation of the rings relative to one another causes seal gas to be pumped between the faces 15, 17 to generate a force which opposes that applied by the bellows 18. Such gas also keeps the faces 15, 17 from contacting one another.

The gas layer, when formed, separates the seals faces 15, 17 from each other and opposes the bellows 18. Herein, at least one of the seal faces 15, 17 can include grooves or other surface features formed therein. The grooves can be configured such that they draw gas in from an inner diameter of one of the face towards it center/inner diameter. Examples of such grooves are shown in FIGS. 2b/2d. As discussed above, in any of these cases, as gas enters the grooves is compressed as one face rotates to create the lift off force that causes the faces to separate.

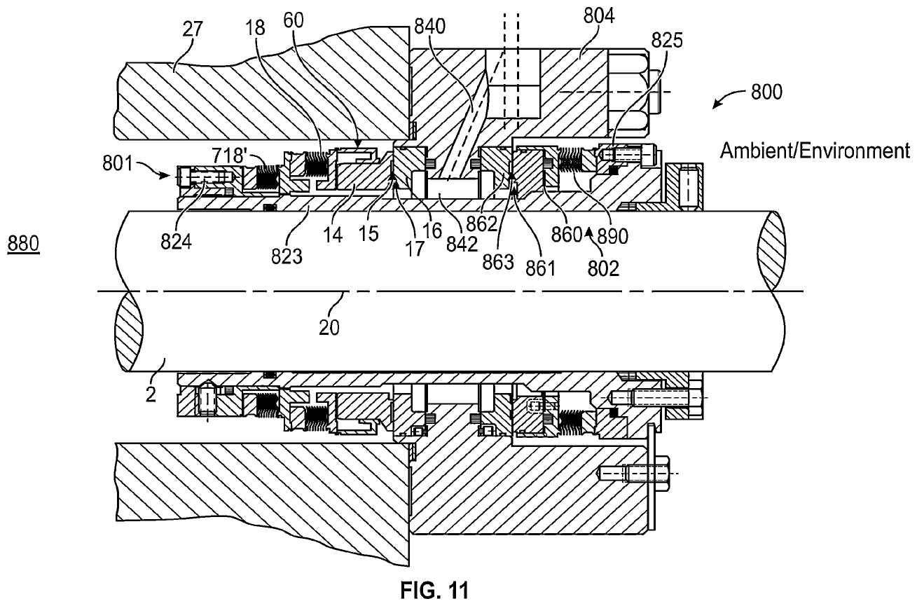

Referring again to FIG. 11, as shown the bellows 18, 718 are connected to and rotates with the shaft 2. The shaft 2 is centered and rotates about a longitudinal axis 20. The seal ring 14 is connected to the bellows 18, 718 and, as such, can rotate with and move axially relative to the shaft 2. The bellows 18 can be connected to the shaft 2 through a sleeve 823.

As shown, an optional attachment element 824 connects the bellows 18 to the sleeve 823 but this could be omitted and the bellows 18 could be connected directly to the sleeve 823.

The assembly includes a housing 804 that can be attached to a body 27 of a rotating machine. The mating ring 16 is attached to housing 804 such that they maintain a fixed relationship to one another. As will be understood, as the shaft 2 moves axially along the longitudinal axis 20 during operation, so will the bellows 18 while the mating ring 16 remains still. The skilled artisan will realize that the compression due to the bellows 18, 718 and the lift off due to the compressed gas can be balanced to achieve a stable distance between the faces 15, 17 during operation.

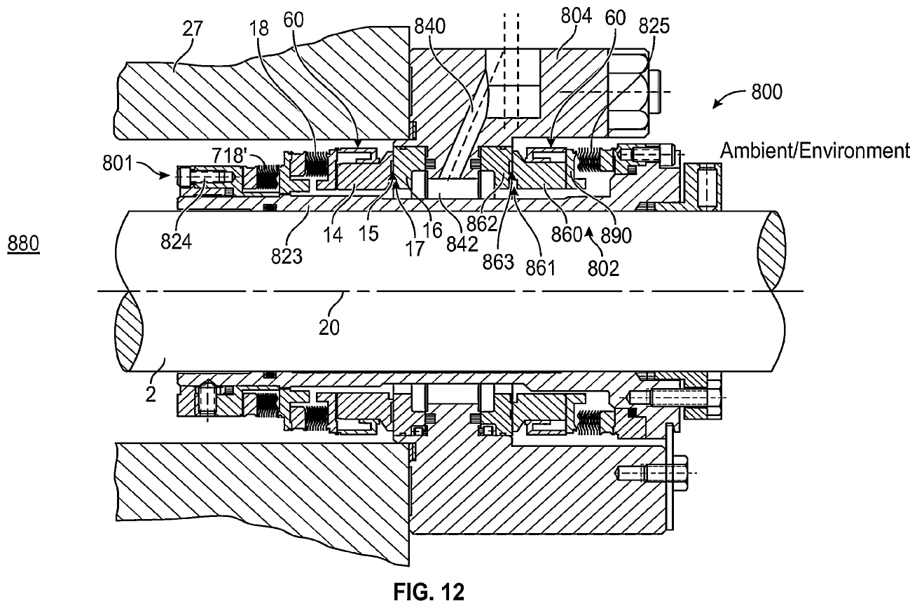

Similar to the process side seal 801, the atmosphere side seal 802 includes an atmosphere side seal ring 860 and an atmosphere side mating ring 862. The atmosphere side seal ring 860 is coupled to the shaft 2 and rotates with it. As shown, the atmosphere side seal ring 860 is connected in a conventional manner that does not include the particular seal ring assembly 60 of the process side seal 802. The skilled artisan will realize that the atmosphere side seal 802 could be so configured which a seal ring assembly 60 as is shown in FIG. 12.

Similar to the process side seal one of the faces 861, 863 of the seal ring or mating rings 860, 862 of the atmosphere side seal 802 can comprise a grooved or textured area, such that the rotation of the rings relative to one another causes seal gas to be pumped between the faces thereof to generate a force which opposes that applied to the seal ring 860 by a biasing device. Such gas also keeps the faces of the atmosphere side seal from contacting one another. As shown in both FIGS. 11 and 12, the biasing device is a bellows 890. In alternative embodiments, the biasing device can be a spring or an equivalent thereof. The seal ring assembly 860 is connected to and biased by biasing member 890 which is coupled to the sleeve 823.

In operation, the rotating shaft 2 can be operably coupled to a pump impeller or other device (not shown) disposed in a process cavity 880 of a rotating machine. Process fluid present in the process cavity 880 can be sealed from the environment by a seal assembly 800. While seal assembly 800 is depicted and described with two seals 801, 802, a greater or fewer number of seals are contemplated. Additionally, in some embodiments, a shroud, bushing, labyrinth, or clearance seal can extend over a radial opening formed between the rotating shaft 2 and the housing 804, thereby further inhibiting the free flow of process fluid from the process cavity 880 to the environment.

As shown the process side bellows 18 and the biasing member 890 are both connected to and rotate with the shaft 2. The shaft 2 is centered and rotates about a longitudinal axis 20. The seal ring 14 is connected to the bellows 18 and, as such, can rotate with and move axially relative to the shaft 2. The bellows 18 can be connected to the shaft 2 through the sleeve 823. As shown, an optional attachment element 824 connects the bellows 18 to the sleeve 823 but this could be omitted and the bellows 18 could be connected directly to the sleeve 823.

Similarly, seal ring assembly 860 is connected to the biasing member 890 and, as such, can rotate with and move axially relative to the shaft 2. The biasing member 890 can be connected to the shaft 2 through the sleeve 823. As shown, an optional attachment element 825 connects the bellows 18 to the sleeve 823 but this could be omitted and the bellows 18 could be connected directly to the sleeve 823.

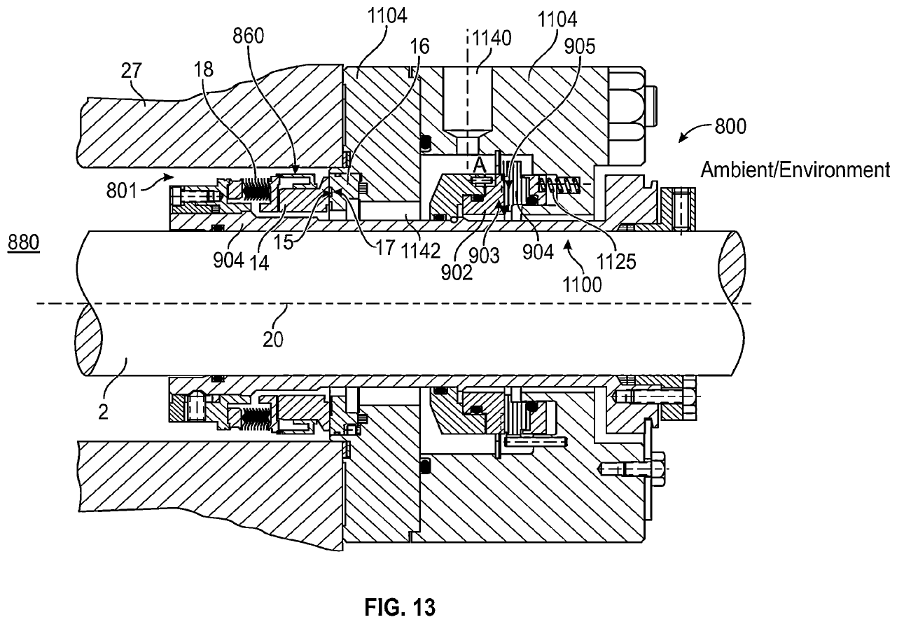

As shown in FIG. 13, alternative paths can be envisioned where at least in the atmosphere side seal the sealing gas flows between seal faces of the rings of the atmosphere side seal 1100 in a direction that is radially inward toward the shaft 2. In FIG. 11, the process side seal 801 is the same or similar to that shown in FIGS. 8 and 9. In this embodiment, the atmosphere side seal 1100 includes a rotating mating ring 902 that is coupled to a sleeve 904. The sleeve 904, in the manner of the sleeve 823 above, rotates with the shaft and thus, so does the mating ring 902. The mating ring 902 includes a rotating face 903.

The atmosphere side seal 1100 also includes a seal ring 904 that is moveably coupled to the housing 1104. The housing 1104 is connected to the body 27 of the rotating machine and as shown is formed at two parts but could be formed as a single element or multiple elements. The seal ring 904 is moveably connected to the housing 1104 by a biasing member 1125 that in this case is illustrated as a spring. The seal ring 904 includes a stationary face 905. The interaction of the spring to the sealing gas film formed between faces 903, 905 is similar to that described above.

Herein, at least one of the seal faces 903, 905 can include grooves or surface texture features formed therein. The features can be configured such that they draw gas in from an outer diameter of one of the face towards it center/inner diameter. Such a configuration is applicable to situations where pressure at the outer diameter is greater than at the inner diameter. Examples of such grooves are shown in FIG. 2a. As discussed above, In any of these cases, as gas enters the feature is compressed as one face rotates to create the lift off force that causes the faces to separate and to compress the biasing member 1125. Arrow A illustrates the direction for gas flow through the second seal 1100.

The housing 1104 surrounds portions of the process side and atmosphere side non-contacting seals 801, 1100 and defines a gas inlet channel 1140 through which gas can pass from outside the seal assembly into a region 1142 (gas chamber) between the process side and atmosphere side non-contacting seals 801, 1100. Similar to the above, a fluidic path can be defined between the rotating rings (e.g., rings 14, 902) and the stationary rings (e.g., rings 16, 904) through which a sealing gas can flow. The sealing gas can be any appropriately dense gas, such as carbon dioxide (CO2), nitrogen (N2), air, steam, or other gases. The sealing gas can be introduced into the fluidic path via the gas inlet channel 1140. Thereafter, the sealing gas can flow through a conduit into the gas chamber 1142, where it can be divided into a process side sealing gas flow and an atmosphere side sealing gas flow. The process side sealing gas flow can flow through the process side seal 801 and into the process cavity 880. The atmosphere side sealing gas flows between the rings 902, 904 of the atmosphere side seal 802 in direction A and is then released to the environment.

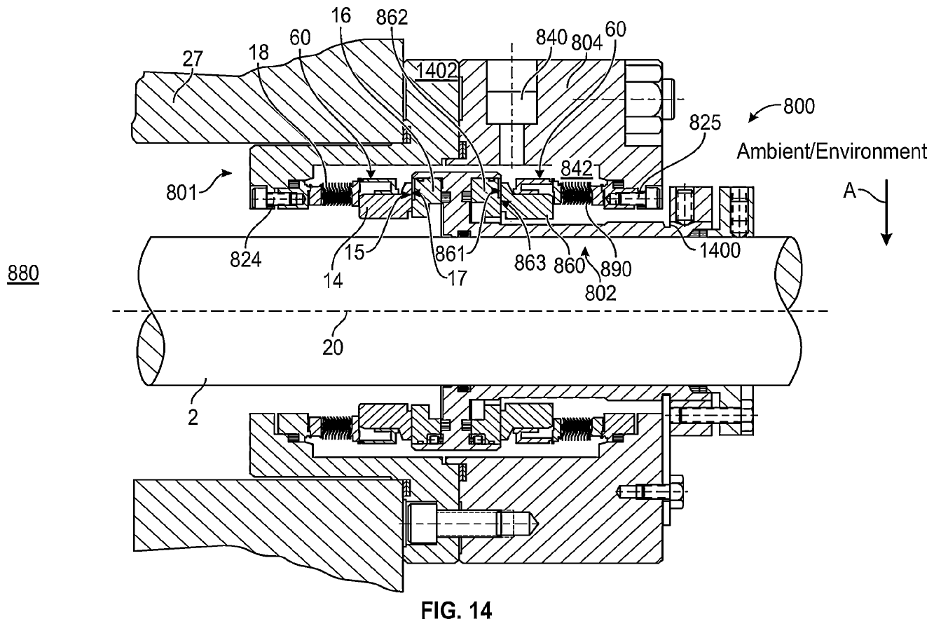

It is contemplated that the configurations shown above could be “reversed” so that the seals of, for example, FIGS. 8-12 are inward pumping rather than outward pumping. That is, and as shown in FIGS. 14-16 below, the seal assembly can be configured such that it “pumps” the sealing gas through the process and atmosphere side seals towards the shaft as opposed to away from it as illustrated in FIG. 10, for example.

With reference now to FIGS. 12-14, an assembly 800 including a process side non-contacting seal 801 and an atmosphere side non-contacting seal 802 is illustrated. In all of these seals, the seal rings of both the process side non-contacting seal 801 and an atmosphere side non-contacting seal 802 are coupled to the housing 804. In all cases, the seal ring of the primary is connected by one or more bellows to the housing 804. In this manner, the seal ring can be urged toward the mating rings. The mating rings on the atmosphere side non-contacting seal are connect to and rotate with the shaft 2 via a sleeve 1400. The sleeve 1400 can support both mating rings 16, 862 and can be fixedly attached to the shaft 2 in known manners. It shall be understood that while the sleeve 1400 is shown as a single piece that couples rotating rings of the process side and atmosphere side non-contacting seals 801, 802 to the shaft 2, the sleeve 1400 could be formed of multiple pieces.

It shall be understood that the exact configuration shown is not required and for generality the terms first and second seals can replace process and atmosphere herein in any configuration.

The assembly includes a housing 804 that surrounds portions of the first and second dry gas seals 801, 802. The housing 804 can be attached to a body 27 of any type or rotating machine that includes as rotating shaft 2 having a shaft axis 20 either directly or with an intermediate ring 1402 as shown. For example, the body 27 can be a pump body.

The housing 804 surrounds portions of the first and second dry gas process and atmosphere side non-contacting seals 801, 802 and defines a gas inlet channel 840 through which gas can pass from outside the seal assembly into a region 842 (gas chamber) between the second seals 801, 802. The manner in which the gas travels from the inlet channel 840, into the gas chamber 842 and though the first and second seals 801, 802 is generally opposite to that as described above. That is, in the embodiments in FIGS. 12-14 the gas flows through the first and second seals 801, 802 from an outer diameter of the seals (and rings that form them) towards the shaft 2 (e.g., towards the inner diameter of the seals and rings that form them).

In the illustrated embodiment, the first and second seals are process and atmospheric sided seals. Thus, as shown, both the process side and atmosphere side seals have two rings, one of which rotates with the shaft 2. It shall be understood that while the sleeve is shown as a single piece that couples rotating rings of the process side and atmosphere side non-contacting seals 801, 802 to the shaft 2, the sleeve 823 could be formed of multiple pieces.

The process side non-contacting seal 801 includes a seal ring 14 and a mating ring 16 configured as above. Due to relative motion between the seal ring 14 and the mating ring 16 a layer of gas is developed between them. In particular, the layer of gas is formed between seal faces 15, 17 of the seal and mating rings 14, 16, respectively, and keeps gas within a chamber 4 from escaping therefrom along a shaft 2. The gas layer is formed from process or sealing gas injected into the non-contacting seal and may be sourced from the chamber 4.

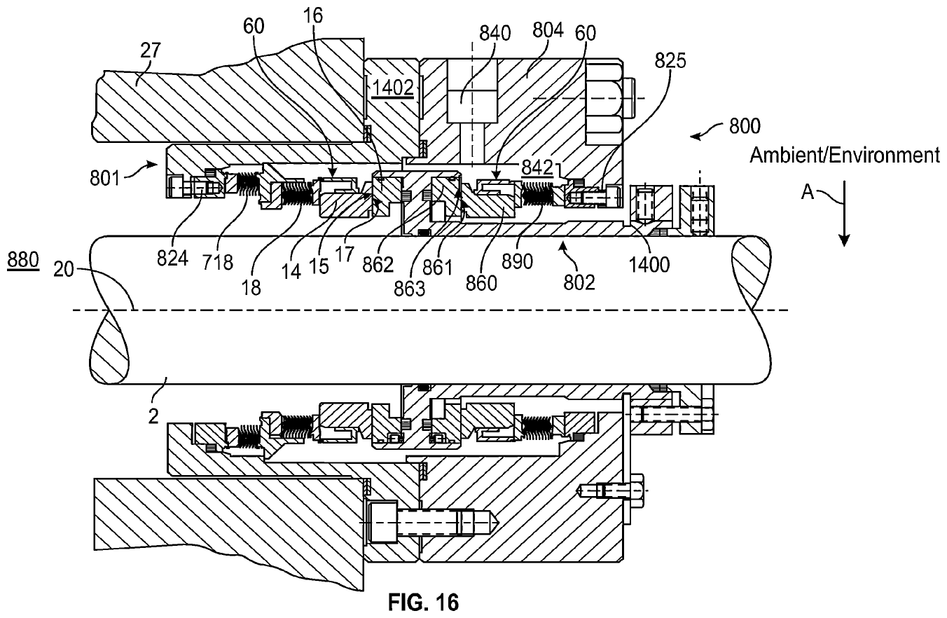

The process side seal 801 can include one or more bellows. As shown, the seal 801 includes bellows 18 that urges the seal ring 14 towards the mating ring 16. Of course, additional bellows could be used to urge the rings together. For example, the process side seal 801 can include a second bellows 718 (FIG. 16) arranged relative to the first bellows 18 in a manner that is the same or similar to that shown in FIG. 7. The bellows 18/718 can be attached to the housing 804/ring 1402 by an optional connection element 842

One of the faces 15, 17 of the seal ring or mating ring 14, 16 can comprise a grooved or textures area, such that the rotation of the rings relative to one another causes seal gas to be pumped between the faces 15, 17 to generate a force which opposes that applied by the bellows 18. Such gas also keeps the faces 15, 17 from contacting one another.

The gas layer, when formed, separates the seals faces 15, 17 from each other and opposes the bellows 18. Herein, at least one of the seal faces 15, 17 can include grooves or other surface features formed therein. The grooves can be configured such that they draw gas in from an outer diameter of one of the face towards it center/inner diameter. Examples of such grooves are shown in FIGS. 2a/2c. Thus, the direction of gas flow through the seals as in the direction A shown in both FIGS. 13-16. In any of these cases, as gas enters the grooves/surface features it is compressed as one face rotates to create the lift off force that causes the faces to separate.

In all of FIGS. 14-16, as shown the bellows 18/718 are connected housing 804 and do not rotate with shaft.

The shaft 2 is centered and rotates about a longitudinal axis 20. The seal ring 14 is connected to the bellows 18 and, as such, can move axially relative to the shaft 2. As shown, an optional attachment element 824 connects the bellows 18/718 to the housing 804/1402 but this could be omitted in certain cases.

The mating ring 16 is attached shaft as described above. As will be understood, as the shaft 2 moves axially along the longitudinal axis 20 during operation, mating ring 16. Thus, the mating ring 16 moves with but not relative to the shaft 2. The skilled artisan will realize that the compression due to the bellows 18 and the lift off due to the compressed gas can be balanced to achieve a stable distance between the faces 15, 17 during operation.

In FIG. 14-16, the seal ring 14 can be held by a seal ring assembly 60 embodying the present invention and that was discussed above with respect to FIGS. 3-6 above. All of the disclosure in the above is, thus, applicable to the seal ring assemblies 60 shown in any of FIGS. 14-16.

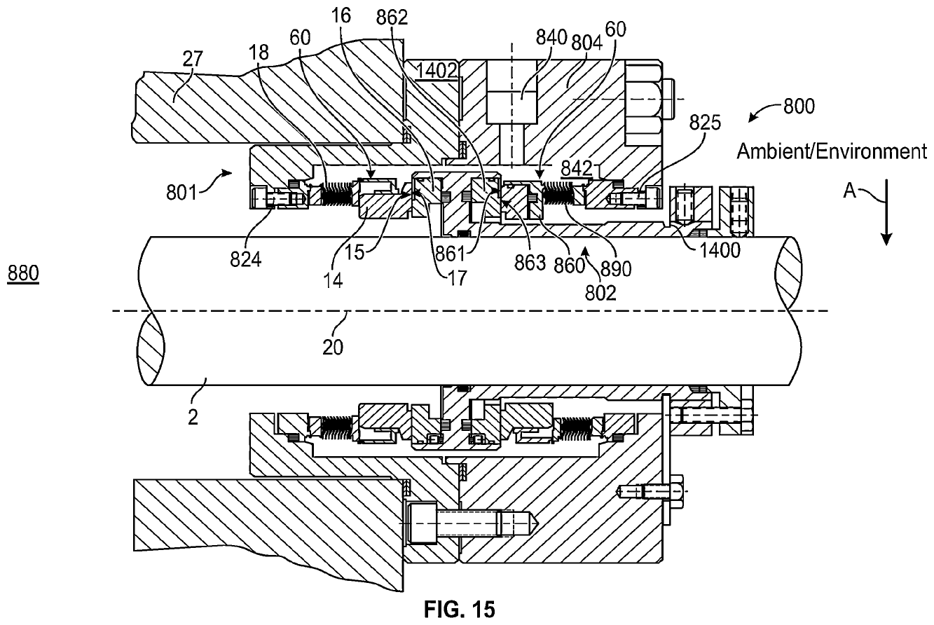

Similar to the process side seal 801, the atmosphere side seal 802 includes an atmosphere side seal ring 860 and an atmosphere side mating ring 862. The atmosphere side seal ring 860 is coupled to the body 804 and does not rotates with the shaft. As shown, the atmosphere side seal ring 860 is connected with a seal ring assembly 60 as described above. However, this is not required and, as shown in FIG. 15, the seal ring 860 of the process side seal 802 can be connected in the conventional manner

Similar to the process side seal one of the faces 861, 863 of the seal ring or mating rings 860, 862 of the atmosphere side seal 802 can comprise a grooved or textured area, such that the rotation of the rings relative to one another causes seal gas to be pumped between the faces thereof to generate a force which opposes that applied to the seal ring 860 by a biasing device. Such gas also keeps the faces of the atmosphere side seal from contacting one another. As shown in FIGS. 14-16, the biasing device is a bellows 890. In alternative embodiments, the biasing device can be a spring or an equivalent thereof. The seal ring assembly 60 is connected to and biased by biasing member 890 which is coupled to the housing 804.

In operation, the rotating shaft 2 can be operably coupled to a pump impeller or other device (not shown) disposed in a process cavity 880 of a rotating machine. Process fluid present in the process cavity 880 can be sealed from the environment by a seal assembly 800. While seal assembly 800 is depicted and described with two seals 801, 802, a greater or fewer number of seals are contemplated. Additionally, in some embodiments, a shroud, bushing, labyrinth, or clearance seal can extend over a radial opening formed between the rotating shaft 2 and the housing 804, thereby further inhibiting the free flow of process fluid from the process cavity 880 to the environment.

Various embodiments of the invention have been described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Thus, any coupling or connection herein may later be called direct in the claims below even if not specifically recited in that manner above. Moreover, the various tasks and process steps described herein can be incorporated into a more comprehensive procedure or process having additional steps or functionality not described in detail herein.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A seal assembly for use with a rotating machine that includes a rotating shaft, the seal assembly comprising:
a mating ring having a mating ring seal face;
a seal ring defining an interior member having an axially extending annular surface and a radially extending seal ring seal face;
a first bellows that urges the seal ring toward the mating ring;
wherein at least one of the mating and seal ring seal faces includes one or more grooves or surface features formed thereon that cause a gas to be drawn between the mating ring and the seal ring due to relative rotation between the seal ring and the mating ring and form a gas layer between the mating ring and the seal ring that urges the seal ring away from the mating ring;
an annular seal ring shell defining an exterior member having a foot portion defining an axially extending engagement surface, the axially extending engagement surface of the foot portion and the axially extending annular surface of the seal ring in direct interference fit along an interference diameter Ds between the axially extending engagement surface of the foot portion and the axially extending annular surface of the seal ring, the seal ring shell further including a radially extending shin portion connected to the foot portion and located radially outward of the foot portion, the foot portion at its engagement surface having an axial length greater than the axial length of the shin portion.

2. The seal assembly of claim 1, wherein the grooves or surface features draw the gas from an inner diameter of the seal ring toward an outer diameter of the seal ring.

3. The seal assembly of claim 1, wherein the grooves or surface features draw the gas from an outer diameter of the seal ring toward an inner diameter of the seal ring.

4. The seal assembly of claim 1, wherein the seal ring shell further includes:
an axially extending thigh portion connected to the shin portion and located radially outward of the shin portion;
a hub extending radially outward from the connection of the shin portion with the thigh portion; and
a back piece secured to the thigh portion;
wherein the first bellows is secured to the back piece.

5. The seal assembly of claim 1, wherein the rotating machine is a pump, a compressor, a blower, or a mixer.

6. The seal assembly of claim 1, wherein the engagement surface is positioned so as to have a near-zero net moment about the center of gravity due to such engagement.

7. The seal assembly of claim 1, wherein the mating ring seal face has a mating ring seal face width and the seal ring seal face has a seal ring seal face width that is smaller than the a mating ring seal face width.

8. The seal assembly of claim 7, wherein the mating ring seal face width is 1.1 to 3 times larger than the seal ring seal face width.

9. The seal assembly of claim 1, further comprising:
a second bellows that urges the first bellows and the seal ring toward the mating ring.

10. A dual pressurized non-contacting seal assembly for use with a rotating machine that includes a rotating shaft, the seal assembly comprising:
a process side non-contacting seal, wherein the process side non-contacting seal includes:
a process side mating ring having a process side mating ring seal face;
a process side seal ring defining an interior member having an axially extending annular surface and a radially extending process side seal ring seal face;
a process side bellows that urges the process side seal ring toward the mating ring;
wherein at least one of the mating and seal ring seal faces includes one or more surface features formed thereon that cause a gas to be drawn between the mating ring and the seal ring due to relative rotation between the seal ring and the mating and form a gas layer between the mating ring and the seal ring that urges the primary ring away from the mating ring;
an annular seal ring shell defining an exterior member having a foot portion defining an axially extending engagement surface, the axially extending engagement surface of the foot portion and the axially extending annular surface of the seal ring in direct interference fit along an interference diameter Ds between the axially extending engagement surface of the foot portion and the axially extending annular surface of the seal ring, the seal ring shell further including a radially extending shin portion connected to the foot portion and located radially outward of the foot portion, the foot portion at its engagement surface having an axial length greater than the axial length of the shin portion.
an atmosphere side non-contacting seal; and
a housing surrounding portions of the process side and atmosphere side non-contacting seals and including a gas inlet channel through which sealing gas can pass from outside the seal assembly into a region between the process side and gas atmosphere side non-contacting seals.

11. The seal assembly of claim 10, wherein the grooves or surface features draw the gas from an inner diameter of the seal ring toward an outer diameter of the seal ring.

12. The seal assembly of claim 10, wherein the grooves or surface features draw the gas from an outer diameter of the seal ring toward an inner diameter of the seal ring.

13. The seal assembly of claim 10, wherein the seal ring shell further includes:
an axially extending thigh portion connected to the shin portion and located radially outward of the shin portion;
a hub extending radially outward from the connection of the shin portion with the thigh portion; and
a back piece secured to the thigh portion, wherein the process side bellows is connected to the back piece.

14. The seal assembly of claim 10, further comprising an atmosphere side bellows that urges the atmosphere side seal ring towards the atmosphere side mating ring.

15. The seal assembly of claim 10, wherein the gas atmosphere side non-contacting seal includes:
an atmosphere side mating ring; and
an atmosphere side seal ring,
wherein one of the atmosphere side seal ring and the atmosphere side mating ring includes one or more grooves or surface features formed thereon that cause sealing gas in the region between the process side and atmosphere side seals to be drawn between the atmosphere side mating ring and the atmosphere side seal ring due to relative rotation between the atmosphere side seal ring and the atmosphere side mating ring and form a gas layer between the second mating ring and the second primary ring.

16. The seal assembly of claim 15, wherein the atmosphere side non-contacting seal includes:
an second annular seal ring shell defining a member having a second foot portion defining a second axially extending engagement surface, the second axially extending engagement surface of the second foot portion and the second axially extending annular surface of the second seal ring in direct interference fit along an interference diameter Ds2 between the second axially extending engagement surface of the second foot portion and the second axially extending annular surface of the second primary ring, the second annular seal ring shell further including a radially extending second shin portion connected to the second foot portion and located radially outward of the second foot portion, the second foot portion at its engagement surface having an axial length greater than the axial length of the second shin portion.

17. The seal assembly of claim 16, further comprising an atmosphere side bellows that urges the atmosphere side seal ring towards the atmosphere side mating ring.

18. The seal assembly of claim 10, further comprising a spring that urges the atmosphere side primary ring towards the atmosphere side mating ring.

19. The seal assembly of claim 10, wherein the rotating machine is a pump or a compressor.

20. The seal assembly of claim 10, wherein the engagement surface is positioned so as to have a near-zero net moment about the center of gravity due to such engagement.
